(19) United States
(12) Patent Application Publication
(10) Pub. No.: US 2017/0322456 A1
(43) Pub. Date: Nov. 9, 2017

(54) PSVA LIQUID CRYSTAL DISPLAY PANEL AND MANUFACTURE METHOD THEREOF

(71) Applicant: Shenzhen China Star Optoelectronics Technology Co. Ltd., Shenzhen, Guangdong (CN)

(72) Inventor: Qiming Gan, Shenzhen City (CN)

(21) Appl. No.: 14/786,552

(22) PCT Filed: Oct. 12, 2015
(86) PCT No.: PCT/CN2015/091728

§ 371 Date: Oct. 23, 2015

(30) Foreign Application Priority Data
Sep. 9, 2015 (CN) 201510571677.5

(51) Int. Cl. G02F 1/1337

(52) U.S. Cl. CPC G02F 1/133711; G02F 1/133788; G02F 2001/133715

(57) ABSTRACT

The present invention provides a PSVA liquid crystal display panel and a manufacture method thereof. The PSVA liquid crystal display panel of the present invention comprises a patterned passivation layer, and the upper surface of the passivation layer is provided with the trenches having kinds of depths. It can remedy the transmittance homogeneity in certain degree, which is beneficial to promote the large view angle property of the PSVA liquid crystal display panel; the manufacture method of the PSVA liquid crystal display panel according to the present invention employs the multi tone mask to form the via hole and the trenches having kinds of depths at the same time by one photolithographic process with one multi tone mask. The production cost is reduced and the production efficiency is promoted.

### FIELD OF THE INVENTION

The present invention relates to a display technology field, and more particularly to a PSVA liquid crystal display panel and a manufacture method thereof.

### BACKGROUND OF THE INVENTION

In recent years, the Thin Film Transistor-LCD (TFT-LCD) has been rapidly developed and applied widely. For the TFT-LCD in the mainstream market, three types, which respectively are Twisted Nematic (TN), Super Twisted Nematic (STN), In-Plane Switching (IPS) and Vertical Alignment (VA) can be illustrated. The VA liquid crystal display possesses extremely high contrast than the liquid crystal displays of other types. It has very wide application in large scale display, such as television or etc.

The polymer-stabilized vertical alignment (PSVA) wide view angle technology can make the liquid crystal display panel possess advantages of faster response time and high transmittance. The distinguishing feature is to form polymer protrusions on the surface of the alignment film to make the liquid crystal molecules have a pre-tilted angle. The general PSVA pixel structure is to accomplish the passivation on the array substrate for protecting the channel, and then the pixel electrode deposed thereon is implemented with pattern process. As shown in FIG. 1, which is a PSVA liquid crystal display panel according to prior art, comprising an upper substrate 100 and a lower substrate 200. The upper substrate 100 comprises a first substrate 110 and a plane type common electrode 120. The lower substrate 200 comprises a second substrate 210, a passivation layer 220 and a pixel electrode 230. The pixel electrode 230 has a pozidriv pattern. However, the pixel electrode 230, which is processed to have the pozidriv pattern, forms pixel electrode branches and slits interval patterns extending toward different directions. It results in the nonuniform electrical field which is formed with the common electrode 120 of the upper substrate 110 corresponding thereto. The electrical field corresponding to the pixel electrode branch region is obviously stronger than the electrical field corresponding the silt region. Accordingly, the uneven brightness phenomenon happens in the pixel.

For solving the existing issues of the PSVA liquid crystal display panel according to prior art, a new PSVA liquid crystal display panel is proposed, which is to form patterns on the passivation layer to obtain a plurality of trenches, and then to cover the passivation layer 22 entirely with the entire surface pixel electrode; in comparison with the PSVA liquid crystal display panel according to prior art, as shown in FIG. 2, the passivation layer 220′ in the PSVA liquid crystal display panel is a patterned passivation layer, comprising a plurality of trenches extending along with various directions, and the pixel electrode 230′ is an entire surface pixel electrode, which is entirely attached to the patterned passivation layer 220′, and has corresponding patterns with the passivation layer 220′. The pixel electrode 230′ penetrates the through hole in the passivation layer 220′ and is connected with the drain of the thin film transistor; nevertheless, the depth of the through hole in the passivation layer 220′ and the depths of the trenches 222 are not equal. Generally, two masks are required to implement photo twice and implement etch twice. The manufacture method of the new PSVA liquid crystal display panel generally comprises steps of:

step 1, as shown in FIG. 3, providing a substrate 210, and manufacturing a thin film transistor on the substrate 210; the thin film transistor comprises a gate, a source and a drain 240;

step 2, as shown in FIG. 4, deposing a passivation layer 220′ on the thin film transistor; coating photoresist on the passivation layer 220′, and employing a first mask to implement exposure, development to the photoresist to obtain a first photoresist layer 510, and the first mask is employed to form the trenches on the passivation layer 220′;

step 3, as shown in FIG. 5, employing the first photoresist layer 510 to be a shielding layer to etch the passivation layer 220′ to obtain a plurality of trenches 222 on the patterned passivation layer 220′;

step 4, as shown in FIG. 6, stripping the first photoresist layer 510, and coating photoresist on the passivation layer 220′, once more, and employing a second mask to implement exposure, development to the photoresist to obtain a second photoresist layer 520, and the second mask is employed to form the through holes in the passivation layer 220′;

step 5, as shown in FIG. 7, employing the second photoresist layer 520 to be a shielding layer to etch the passivation layer 220′ to obtain the through hole 224 in the passivation layer 220′;

step 6, as shown in FIG. 8, forming the pixel electrode 230′ on the passivation layer 220′, and the pixel electrode 230′ penetrates the through hole 224 in the passivation layer and is connected with the drain.

According to the manufacture process of prior art, in case that the trenches of more depths are manufactured on the passivation layer, at least two masks are required to implement the photolithographic process at least twice. Consequently, it brings the increase of the cost and the trivial details of the process to reduce the production efficiency.

### SUMMARY OF THE INVENTION

An objective of the present invention is to provide a PSVA liquid crystal display panel comprising a patterned passivation layer, and the upper surface of the passivation layer is provided with the trenches having kinds of depths. It can remedy the transmittance homogeneity in certain degree, which is beneficial to promote the large view angle property of the PSVA liquid crystal display panel.

Another objective of the present invention is to provide a manufacture method of a PSVA liquid crystal display panel employing the multi tone mask to form the via hole and the trenches having kinds of depths at the same time by one photolithographic process with one multi tone mask. The production cost is reduced and the production efficiency is promoted.

For realizing the aforesaid objectives, the present invention provides a PSVA liquid crystal display panel, comprising an upper substrate, a lower substrate oppositely located to the upper substrate and a liquid crystal layer located between the upper substrate and the lower substrate;

the upper substrate comprises a first substrate, and a common electrode located on the first substrate;

the lower substrate comprises a plurality of pixel units, and each pixel unit comprises a second substrate, a thin film transistor located on the second substrate, a passivation layer located on the second substrate and the thin film transistor, and a pixel electrode located on the passivation layer;

an upper surface of the passivation layer is provided with a plurality of trenches, and the plurality of trenches have at least three kinds of depths;

the pixel electrode is an entire surface electrode of which a thickness is uniform and continuous; the pixel electrode is entirely attached to the passivation layer which is patterned and comprises a corresponding pattern with the passivation layer. A thickness of the passivation layer is great than or equal to 5000 Å.

A thickness of the passivation layer is 6000 Å, and the trenches have three kinds of depths, which respectively are 2000 Å, 3000 Å and 4000 Å.

The thin film transistor comprises a gate, a source and a drain, and the passivation layer comprises a via hole correspondingly located above the drain, and the pixel electrode penetrates the via hole and is connected with the drain of the thin film transistor.

The via hole and the trenches are manufactured at the same time by one photolithographic process with one multi tone mask.

The present invention further provides a manufacture method of a PSVA liquid crystal display panel, comprising steps of:

step 1, providing a second substrate, and manufacturing a thin film transistor on the second substrate; the thin film transistor comprises a gate, a source and a drain;

step 2, deposing a passivation layer on the thin film transistor and the second substrate;

step 3, coating photoresist on the passivation layer, and employing a multi tone mask to implement exposure, development to the photoresist, and the multi tone mask comprises a full exposure region employed for forming a via hole in the passivation layer, and a half exposure region employed for forming trenches in the passivation layer, and the half exposure region comprises at least three kinds of transmittances employed for forming the trenches of at least three kinds of depths;

step 4, employing the photoresist layer to be a shielding layer to etch the passivation layer to obtain the photoresist layer which is patterned, and the patterned photoresist layer comprises a plurality of trenches on an upper surface of the passivation layer, and a via hole penetrating the passivation layer and correspondingly being located above the drain, and the trenches have at least three kinds of depths;

step 5, stripping the photoresist which is remained, and forming a pixel electrode on the photoresist layer with sputter to obtain a lower substrate;

the pixel electrode is entirely attached to the passivation layer which is patterned and comprises a corresponding pattern with the passivation layer, and the pixel electrode penetrates the via hole and is connected with the drain;

step 6, providing an upper substrate, and the upper substrate comprises a first substrate, and a common electrode located on the first substrate; implementing cell process to the upper substrate and the lower substrate to obtain the PSVA liquid crystal display panel.

A thickness of the passivation layer deposed in the step 2 is great than or equal to 5000 Å.

The half exposure region of the multi tone mask provided in the step 3 comprises at least three kinds of transmittances employed for forming the trenches of at least three kinds of depths, and the trenches formed in the step 4 have three kinds of depths, which respectively are 2000 Å, 3000 Å and 4000 Å.

The thickness of the passivation layer deposed in the step 2 is 6000 Å.

In the step 4, a dry etching process is employed to etch the passivation layer.

The present invention further provides a PSVA liquid crystal display panel, comprising an upper substrate, a lower substrate oppositely located to the upper substrate and a liquid crystal layer located between the upper substrate and the lower substrate;

the upper substrate comprises a first substrate, and a common electrode located on the first substrate;

the lower substrate comprises a plurality of pixel units, and each pixel unit comprises a second substrate, a thin film transistor located on the second substrate, a passivation layer located on the second substrate and the thin film transistor, and a pixel electrode located on the passivation layer;

an upper surface of the passivation layer is provided with a plurality of trenches, and the plurality of trenches have at least three kinds of depths;

the pixel electrode is an entire surface electrode of which a thickness is uniform and continuous; the pixel electrode is entirely attached to the passivation layer which is patterned and comprises a corresponding pattern with the passivation layer;

wherein a thickness of the passivation layer is great than or equal to 5000 Å;

wherein the thin film transistor comprises a gate, a source and a drain, and the passivation layer comprises a via hole correspondingly located above the drain, and the pixel electrode penetrates the via hole and is connected with the drain of the thin film transistor;

wherein the via hole and the trenches are manufactured at the same time by one photolithographic process with one multi tone mask.

The benefits of the present invention are: the present invention provides a PSVA liquid crystal display panel and a manufacture method thereof. The PSVA liquid crystal display panel of the present invention comprises a patterned passivation layer, and the upper surface of the passivation layer is provided with the trenches having kinds of depths. It can remedy the transmittance homogeneity in certain degree, which is beneficial to promote the large view angle property of the PSVA liquid crystal display panel; the manufacture method of the PSVA liquid crystal display panel according to the present invention employs the multi tone mask to form the via hole and the trenches having kinds of depths at the same time by one photolithographic process with one multi tone mask. The production cost is reduced and the production efficiency is promoted.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a stereoscopic structure diagram of a PSVA liquid crystal display panel according to prior art;

FIG. 2 is a stereoscopic structure diagram of another PSVA liquid crystal display panel according to prior art;

FIG. 3 is a diagram of the step 1 in a manufacture method of the PSVA liquid crystal display panel in FIG. 2;

FIG. 4 is a diagram of the step 2 in a manufacture method of the PSVA liquid crystal display panel in FIG. 2;

FIG. 5 is a diagram of the step 3 in a manufacture method of the PSVA liquid crystal display panel in FIG. 2;

FIG. 6 is a diagram of the step 4 in a manufacture method of the PSVA liquid crystal display panel in FIG. 2;

FIG. 7 is a diagram of the step 5 in a manufacture method of the PSVA liquid crystal display panel in FIG. 2;

FIG. 8 is a diagram of the step 6 in a manufacture method of the PSVA liquid crystal display panel in FIG. 2;

FIG. 9 is a flowchart of a manufacture method of a PSVA liquid crystal display panel according to the present invention;

FIG. 10 is a diagram of the step 3 in the manufacture method of the PSVA liquid crystal display panel according to the present invention;

FIG. 11 is a diagram of the step 4 in the manufacture method of the PSVA liquid crystal display panel according to the present invention;

FIG. 12 is a diagram of the step 5 in the manufacture method of the PSVA liquid crystal display panel according to the present invention.

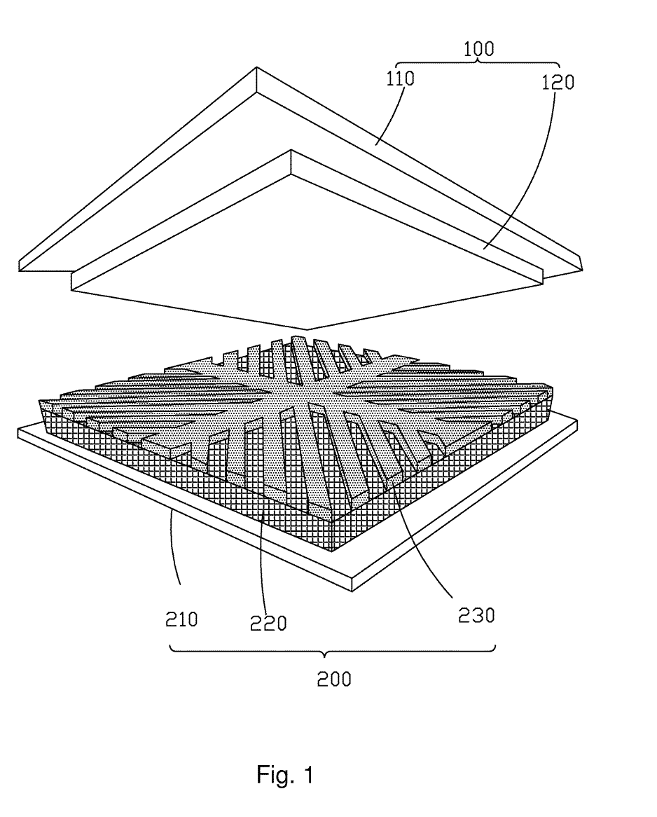

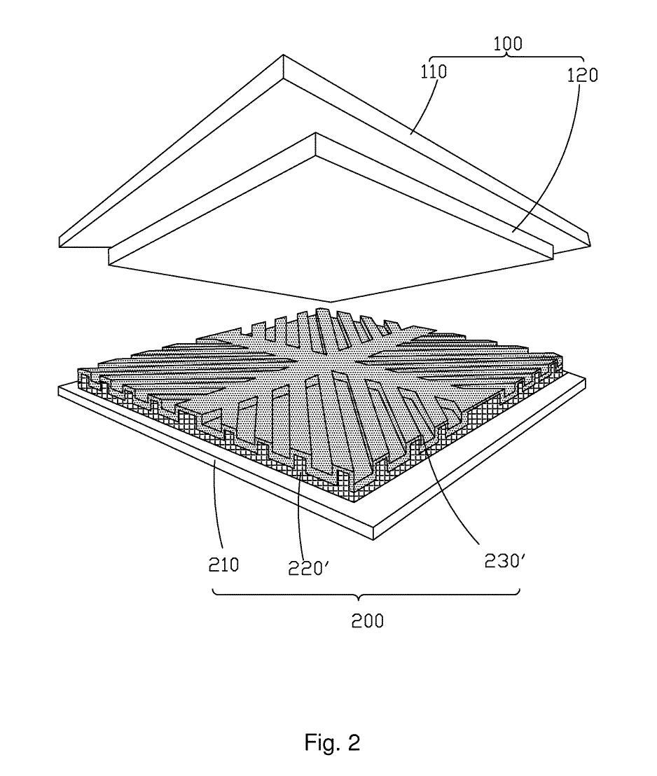

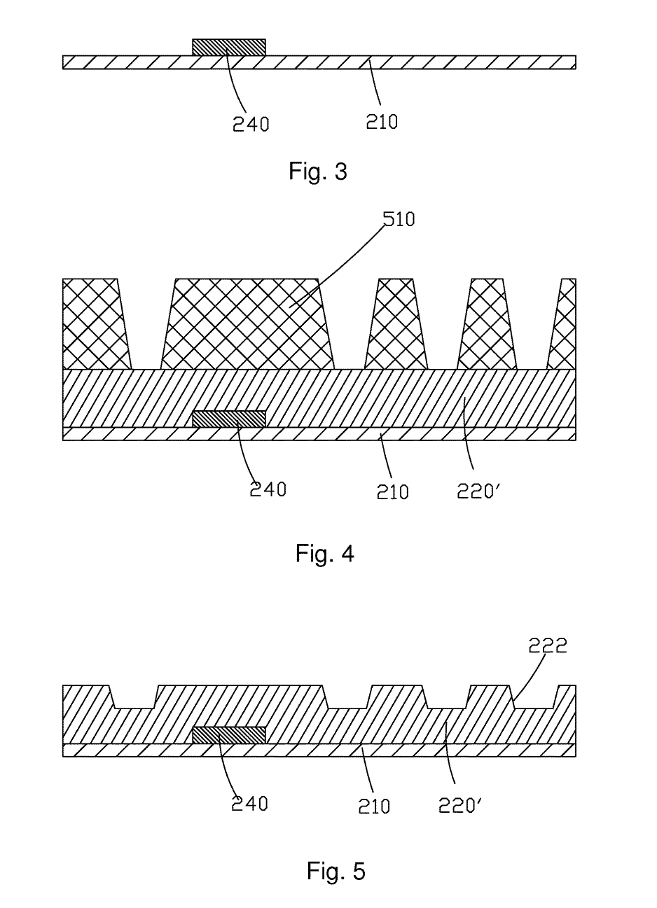

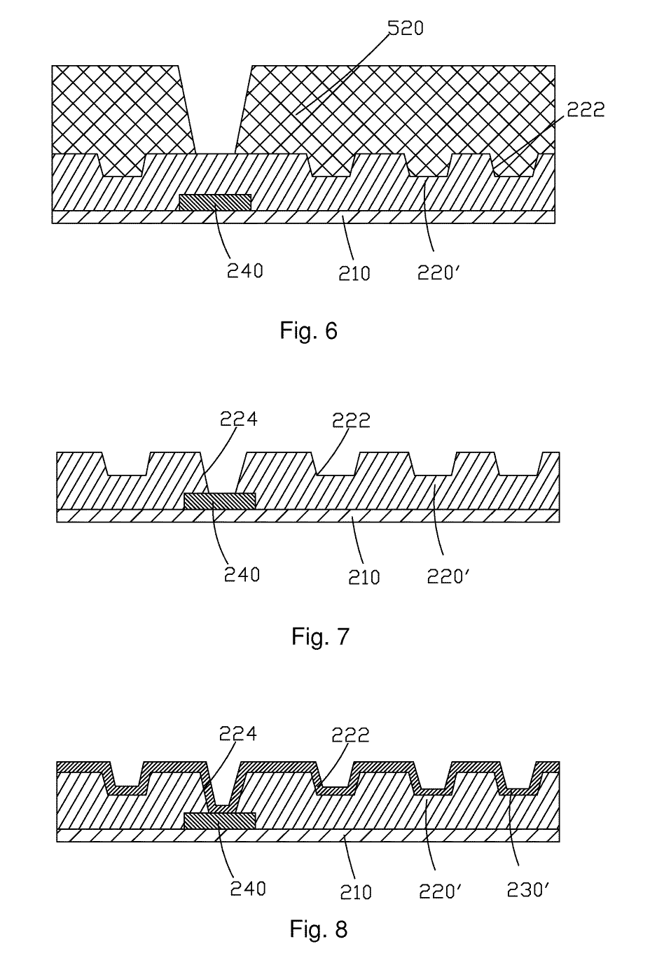

### DETAILED DESCRIPTION OF PREFERRED EMBODIMENTS

The VA liquid crystal display possesses extremely high contrast than the liquid crystal displays of other types. It has very wide application in large scale display, such as television or etc.

Please refer to FIG. 12. The present invention provides a PSVA liquid crystal display panel, comprising an upper substrate, a lower substrate 2 oppositely located to the upper substrate and a liquid crystal layer located between the upper substrate and the lower substrate 2;

the upper substrate comprises a first substrate, and a common electrode located on the first substrate;

the lower substrate 2 comprises a plurality of pixel units, and each pixel unit comprises a second substrate 21, a thin film transistor located on the second substrate 21, a passivation layer 22 located on the second substrate 21 and the thin film transistor, and a pixel electrode 23 located on the passivation layer 22;

an upper surface of the passivation layer 22 is provided with a plurality of trenches 221, and the plurality of trenches 221 have at least three kinds of depths;

the pixel electrode 23 is an entire surface electrode of which a thickness is uniform and continuous; the pixel electrode 23 is entirely attached to the passivation layer 22 which is patterned and comprises a corresponding pattern with the passivation layer 22;

Specifically, a thickness of the passivation layer 22 is great than or equal to 5000 Å. Preferably, the thickness of the passivation layer 22 is 6000 Å.

Specifically, the trenches 221 have three kinds of depths, which respectively are 2000 Å, 3000 Å and 4000 Å.

Specifically, the thin film transistor comprises a gate, a source and a drain 24, and the passivation layer 22 comprises a via hole 223 correspondingly located above the drain 24, and the pixel electrode 23 penetrates the via hole 223 and is connected with the drain 24.

Specifically, the via hole 223 and the trenches 221 are manufactured at the same time by one photolithographic process with one Multi Tone Mask (MTM).

In the aforesaid PSVA liquid crystal display panel, by providing the plurality of trenches 221 having kinds of depths on the upper surface of the passivation layer 22, and then covering the upper surface of the passivation layer 22 with the entire surface pixel electrode 23. Then, the pixel electrode 23 is entirely attached to the passivation layer 22 which is patterned and comprises a corresponding pattern with the passivation layer 22. Because the trenches 221 have kinds of depths, the liquid crystal display panel has different transmittances and different view angle properties at the trenches 221 of different depths, which is beneficial to promote the large view angle property of the PSVA liquid crystal display panel.

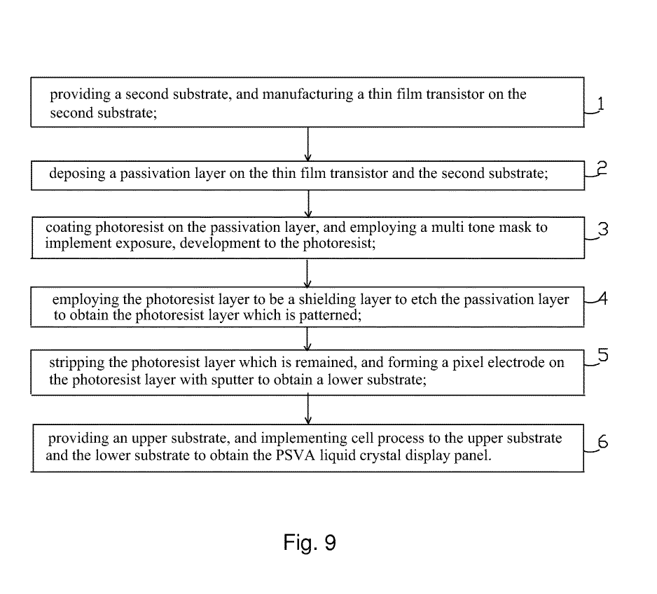

Please refer to FIG. 9. The present invention further provides a manufacture method of a PSVA liquid crystal display panel, comprising steps of:

step 1, providing a second substrate 21, and manufacturing a thin film transistor on the second substrate 21; the thin film transistor comprises a gate, a source and a drain 24;

step 2, deposing a passivation layer 22 on the thin film transistor and the second substrate 22;

specifically, the thickness of the second substrate 22 is great than or equal to 5000 Å, and preferably, the thickness of the passivation layer 22 is 6000 Å;

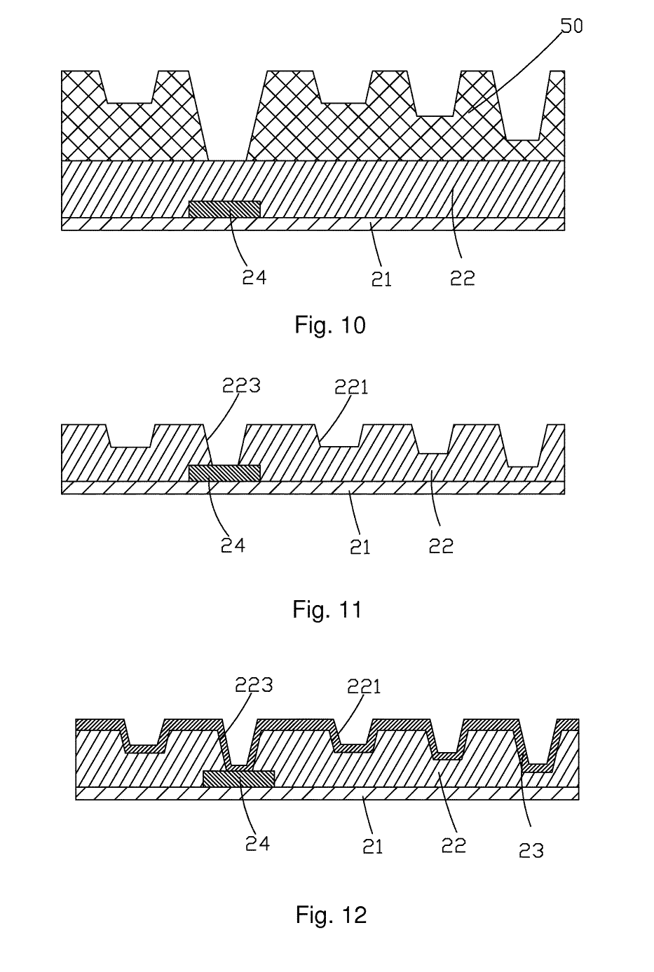

step 3, as shown in FIG. 10, coating photoresist on the passivation layer 22, and employing a multi tone mask to implement exposure, development to the photoresist to obtain a photoresist layer 50, and the multi tone mask comprises a full exposure region employed for forming a via hole in the passivation layer 22, and a half exposure region employed for forming trenches in the passivation layer 22, and the half exposure region comprises at least three kinds of transmittances employed for forming the trenches of at least three kinds of depths;

specifically, the pattern of the multi tone mask in the step 3 is transferred onto the photoresist layer 50;

step 4, as shown in FIG. 11, employing the photoresist layer 50 to be a shielding layer to etch the passivation layer 22 to obtain the photoresist layer 22 which is patterned, and the patterned photoresist layer 22 comprises a plurality of trenches 221 on an upper surface of the passivation layer 22, and a via hole 223 penetrating the passivation layer 22 and correspondingly being located above the drain 24, and the trenches 221 have at least three kinds of depths;

Specifically, in the step 4, a dry etching process is employed to etch the passivation layer 22;

Preferably, the half exposure region of the multi tone mask provided in the step 3 comprises at least three kinds of transmittances employed for forming the trenches of at least three kinds of depths, and the trenches 221 formed in the step 4 have three corresponding kinds of depths, which respectively are 2000 Å, 3000 Å and 4000 Å.

step 5, as shown in FIG. 12, stripping the photoresist layer 50 which is remained, and forming a pixel electrode 23 on the photoresist layer 22 with sputter to obtain a lower substrate 2;

the pixel electrode 23 is entirely attached to the passivation layer 22 which is patterned and comprises a corresponding pattern with the passivation layer 22, and the pixel electrode 23 penetrates the via hole 223 and is connected with the drain 24;

step 6, providing an upper substrate, and the upper substrate comprises a first substrate, and a common electrode located on the first substrate; implementing cell process to the upper substrate and the lower substrate to obtain the PSVA liquid crystal display panel.

In the aforesaid manufacture method of the PSVA liquid crystal display panel, one multi tone mask is employed to form the via hole 223 in the passivation layer 22 and the trenches 221 having kinds of depths on the upper surface of the passivation layer 22 at the same time in one photolithographic process. Thus, the amount of the masks can be decreased, and the manufacture processes can be reduced. The cost can be saved and the production efficiency can be promoted.

In conclusion, the present invention provides a PSVA liquid crystal display panel and a manufacture method thereof. The PSVA liquid crystal display panel of the present invention comprises a patterned passivation layer, and the upper surface of the passivation layer is provided with the trenches having kinds of depths. It can remedy the transmittance homogeneity in certain degree, which is beneficial to promote the large view angle property of the PSVA liquid crystal display panel; the manufacture method of the PSVA liquid crystal display panel according to the present invention employs the multi tone mask to form the via hole and the trenches having kinds of depths at the same time by one photolithographic process with one multi tone mask. The production cost is reduced and the production efficiency is promoted.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A PSVA liquid crystal display panel, comprising an upper substrate, a lower substrate oppositely located to the upper substrate and a liquid crystal layer located between the upper substrate and the lower substrate;
the upper substrate comprises a first substrate, and a common electrode located on the first substrate;
the lower substrate comprises a plurality of pixel units, and each pixel unit comprises a second substrate, a thin film transistor located on the second substrate, a passivation layer located on the second substrate and the thin film transistor, and a pixel electrode located on the passivation layer;
an upper surface of the passivation layer is provided with a plurality of trenches, and the plurality of trenches have at least three kinds of depths;
the pixel electrode is an entire surface electrode of which a thickness is uniform and continuous; the pixel electrode is entirely attached to the passivation layer which is patterned and comprises a corresponding pattern with the passivation layer.

2. The PSVA liquid crystal display panel according to claim 1, wherein a thickness of the passivation layer is great than or equal to 5000 Å.

3. The PSVA liquid crystal display panel according to claim 1, wherein a thickness of the passivation layer is 6000 Å, and the trenches have three kinds of depths, which respectively are 2000 Å, 3000 Å and 4000 Å.

4. The PSVA liquid crystal display panel according to claim 1, wherein the thin film transistor comprises a gate, a source and a drain, and the passivation layer comprises a via hole correspondingly located above the drain, and the pixel electrode penetrates the via hole and is connected with the drain of the thin film transistor.

5. The PSVA liquid crystal display panel according to claim 4, wherein the via hole and the trenches are manufactured at the same time by one photolithographic process with one multi tone mask.

6. A manufacture method of a PSVA liquid crystal display panel, comprising steps of:
step 1, providing a second substrate, and manufacturing a thin film transistor on the second substrate; the thin film transistor comprises a gate, a source and a drain;
step 2, deposing a passivation layer on the thin film transistor and the second substrate;
step 3, coating photoresist on the passivation layer, and employing a multi tone mask to implement exposure, development to the photoresist to obtain a photoresist layer, and the multi tone mask comprises a full exposure region employed for forming a via hole in the passivation layer, and a half exposure region employed for forming trenches in the passivation layer, and the half exposure region comprises at least three kinds of transmittances employed for forming the trenches of at least three kinds of depths;
step 4, employing the photoresist layer to be a shielding layer to etch the passivation layer to obtain the photoresist layer which is patterned, and the patterned photoresist layer comprises a plurality of trenches on an upper surface of the passivation layer, and a via hole penetrating the passivation layer and correspondingly being located above the drain, and the trenches have at least three kinds of depths;
step 5, stripping the photoresist layer which is remained, and forming a pixel electrode on the photoresist layer with sputter to obtain a lower substrate;
the pixel electrode is entirely attached to the passivation layer which is patterned and comprises a corresponding pattern with the passivation layer, and the pixel electrode penetrates the via hole and is connected with the drain;
step 6, providing an upper substrate, and the upper substrate comprises a first substrate, and a common electrode located on the first substrate; implementing cell process to the upper substrate and the lower substrate to obtain the PSVA liquid crystal display panel.

7. The manufacture method of the PSVA liquid crystal display panel according to claim 6, wherein a thickness of the passivation layer deposed in the step 2 is great than or equal to 5000 Å.

8. The manufacture method of the PSVA liquid crystal display panel according to claim 7, wherein the half exposure region of the multi tone mask provided in the step 3 comprises at least three kinds of transmittances employed for forming the trenches of at least three kinds of depths, and the trenches formed in the step 4 have three kinds of depths, which respectively are 2000 Å, 3000 Å and 4000 Å.

9. The manufacture method of the PSVA liquid crystal display panel according to claim 7, wherein the thickness of the passivation layer deposed in the step 2 is 6000 Å.

10. The manufacture method of the PSVA liquid crystal display panel according to claim 6, wherein in the step 4, a dry etching process is employed to etch the passivation layer.

11. A PSVA liquid crystal display panel, comprising an upper substrate, a lower substrate oppositely located to the upper substrate and a liquid crystal layer located between the upper substrate and the lower substrate;
the upper substrate comprises a first substrate, and a common electrode located on the first substrate;
the lower substrate comprises a plurality of pixel units, and each pixel unit comprises a second substrate, a thin film transistor located on the second substrate, a passivation layer located on the second substrate and the thin film transistor, and a pixel electrode located on the passivation layer;
an upper surface of the passivation layer is provided with a plurality of trenches, and the plurality of trenches have at least three kinds of depths;
the pixel electrode is an entire surface electrode of which a thickness is uniform and continuous; the pixel electrode is entirely attached to the passivation layer which is patterned and comprises a corresponding pattern with the passivation layer;
wherein a thickness of the passivation layer is great than or equal to 5000 Å;
wherein the thin film transistor comprises a gate, a source and a drain, and the passivation layer comprises a via hole correspondingly located above the drain, and the pixel electrode penetrates the via hole and is connected with the drain of the thin film transistor;
wherein the via hole and the trenches are manufactured at the same time by one photolithographic process with one multi tone mask.

12. The PSVA liquid crystal display panel according to claim 11, wherein a thickness of the passivation layer is 6000 Å, and the trenches have three kinds of depths, which respectively are 2000 Å, 3000 Å and 4000 Å.
